(19) United States
(12) Patent Application Publication
(10) Pub. No.: US 2021/0058520 A1
(43) Pub. Date: Feb. 25, 2021

(54) IMAGE READING APPARATUS THAT DISPLAYS IMAGE OR TEXT ACQUIRED THROUGH NETWORK, AND IMAGE FORMING APPARATUS

(71) Applicant: KYOCERA Document Solutions Inc., Osaka (JP)

(72) Inventor: Takushi DANDOKO, Osaka (JP)

(73) Assignee: KYOCERA Document Solutions Inc., Osaka (JP)

(21) Appl. No.: 16/994,107

(22) Filed: Aug. 14, 2020

(30) Foreign Application Priority Data
Aug. 21, 2019 (JP) 2019-151524

(51) Int. Cl. H04N 1/00

(52) U.S. Cl. CPC H04N 1/00214; H04N 1/00233; H04N 1/00331

(57) ABSTRACT

An image reading apparatus includes an operation device and a controller. The operation device is used by a user to input an instruction to select one of an image of a source document read by an image reading device and a character string in a text included in the image, as a search condition. The controller acquires, when the instruction designating the image as the search condition is inputted, a search result obtained through a search performed by a search engine using the image as the search condition, and displays the search result on a display device, and acquires, when the instruction designating the character string in the text as the search condition is inputted, a search result obtained through a search performed by the search engine using the character string in the text as the search condition, and displays the search result on the display device.

### INCORPORATION BY REFERENCE

This application claims priority to Japanese Patent Application No. 2019-151524 filed on Aug. 21, 2019, the entire contents of which are incorporated by reference herein.

### BACKGROUND

The present disclosure relates to an image forming apparatus that reads an image of a source document and records the image on a recording sheet, and in particular to a technique to acquire an image or a text through a network, and display the same.

In an image forming apparatus, an image reading device reads an image of a source document, and an image forming device prints the image of the source document, on a recording sheet. Some specific image forming apparatuses are configured to access a web page through a network, to display the web page for viewing. In this case, the uniform resource locator (URL) of the web page that has been viewed is recorded on a URL table, and a character string of a hypertext in the web page designated by the user is recorded on a character string table. Then the image forming apparatus acquires the web page corresponding to the URL recorded on the URL table, and the web page linked to the hypertext character string recorded on the character string table, and prints these web pages in a combined form.

### SUMMARY

The disclosure proposes further improvement of the foregoing technique.

In an aspect, the disclosure provides an image reading apparatus including a display device, an image reading device, an operation device, and a control device. The image reading device reads an image of a source document. The operation device is used by a user to input an instruction to select one of the image of the source document read by the image reading device, and a character string in a text included in the image, as a search condition. The control device includes a processor, and acts as a controller when the processor executes a control program. The controller (i) acquires, when the instruction designating the image as the search condition is inputted through the operation device, a search result obtained through a search performed by a search engine using the image as the search condition, and causes the display device to display the search result, and (ii) acquires, when the instruction designating the character string in the text as the search condition is inputted through the operation device, a search result obtained through a search performed by the search engine using the character string in the text as the search condition, and causes the display device to display the search result.

In another aspect, the disclosure provides an image forming apparatus including the foregoing image reading apparatus, and an image forming device that forms an image on a recording medium.

### BRIEF DESCRIPTION OF THE DRAWINGS

FIG. 1 is a cross-sectional view showing an image forming apparatus according to an embodiment of the disclosure.

FIG. 2 is a cross-sectional view showing an image reading device provided on the image forming apparatus.

FIG. 3 is a perspective view showing the appearance of the image reading device.

FIG. 4 is a functional block diagram showing an essential internal configuration of the image forming apparatus.

FIG. 5 is a flowchart showing a control process for searching and acquiring, through a network, another image or a text related to the image of a source document read by the image reading device.

FIG. 6 is a schematic drawing showing an initial screen displayed on a display device.

FIG. 7 is a schematic drawing showing an example of a dialog box displayed on the display device.

FIG. 8A to FIG. 8C are schematic drawings sequentially showing a transition of a screen of the display device, after a source document image is designated as a search condition, and until another image is retrieved.

FIG. 9A to FIG. 9C are schematic drawings sequentially showing a transition of the screen of the display device, after a character string of the text included in the source document image is designated as a search condition, and until another text is retrieved.

FIG. 10 is a schematic drawing showing an example of the source document containing a plurality of images.

FIG. 11 is a schematic drawing showing browsers displayed on the display device, respectively corresponding to the plurality of images.

FIG. 12 is a schematic drawing showing browsers displayed on the display device, respectively corresponding to the plurality of images.

FIG. 13A to FIG. 13C are schematic drawings each showing the browser displayed on the display device, corresponding to one of the plurality of images.

### DETAILED DESCRIPTION

Hereafter, an image reading apparatus and an image forming apparatus according to an embodiment of the disclosure will be described, with reference to the drawings. The image reading apparatus according to the embodiment of the disclosure will be described, as an apparatus incorporated in an image forming apparatus including an image forming device.

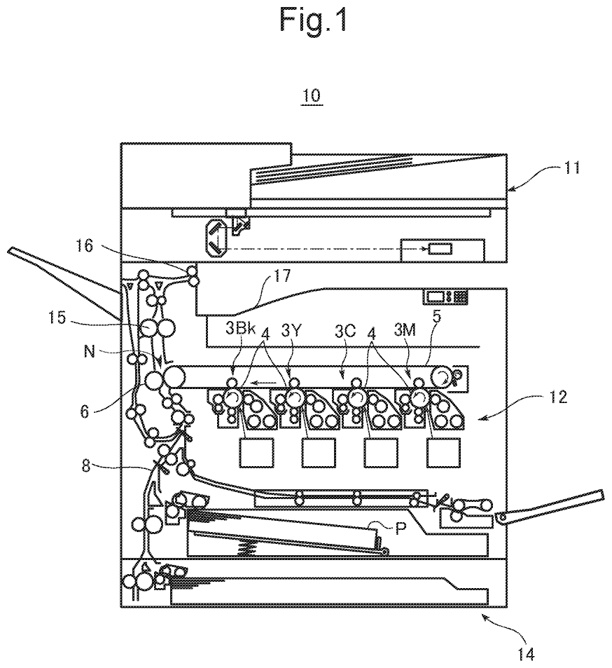

FIG. 1 is a cross-sectional view showing the image forming apparatus according to the embodiment of the disclosure. The image forming apparatus 10 includes an image reading device 11 and an image forming device 12. The image reading apparatus corresponds to a configuration in which the image forming unit 12 is omitted from the image forming apparatus 10, for example.

The image reading device 11 includes an image sensor that optically reads an image of the source document, and the analog output from the image sensor is converted into a digital signal, so that image data representing the image of the source document is generated.

The image forming device 12 is configured to print an image represented by the mentioned image data, or image data received from outside, on a recording sheet, and includes an image forming unit 3M for magenta, an image forming unit 3C for cyan, an image forming unit 3Y for yellow, and an image forming unit 3Bk for black. In each of the image forming units 3M, 3C, 3Y, and 3Bk, the surface of a photoconductor drum 4 is uniformly charged, and an electrostatic latent image is formed on the surface of the photoconductor drum 4 by exposure. Then the electrostatic latent image on the surface of the photoconductor drum 4 is developed into a toner image, and the toner image on the photoconductor drum 4 is transferred to an intermediate transfer roller 5. Thus, the color toner image is formed on the intermediate transfer roller 5. The color toner image is transferred, as secondary transfer, to the recording sheet P transported along a transport route 8 from a paper feed device 14, at a nip region N defined between the intermediate transfer roller 5 and a secondary transfer roller 6.

Thereafter, the recording sheet P is press-heated in a fixing device 15, so that the toner image on the recording sheet P is fixed by thermal compression, and then the recording sheet P is discharged to an output tray 17 through a discharge roller 16.

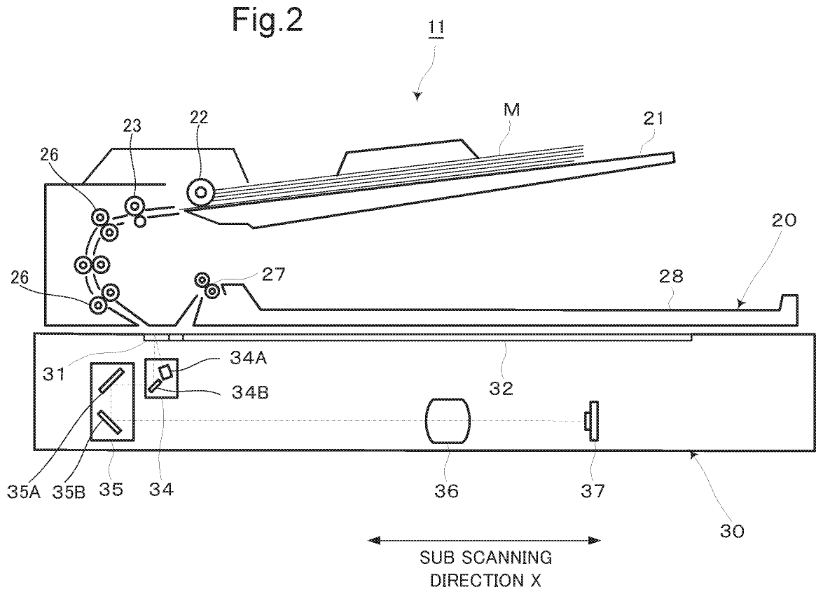

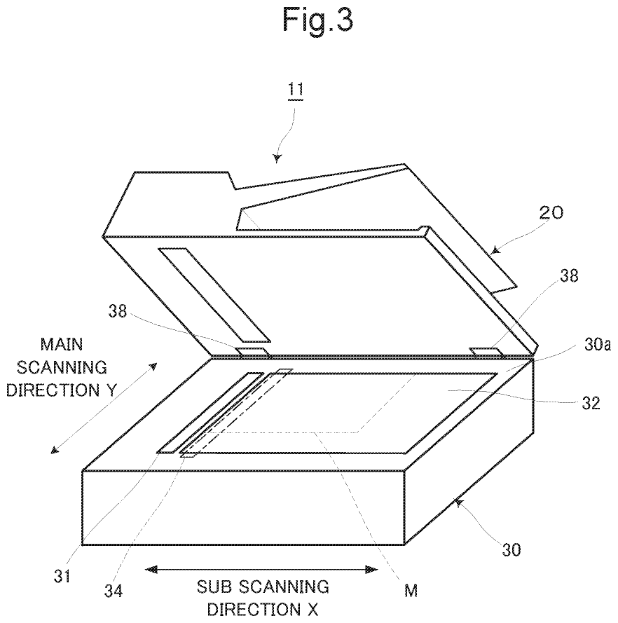

The outline of the configuration of the image reading device 11 will now be described. FIG. 2 is a cross-sectional view showing a mechanical structure of the image reading device 11. FIG. 3 is a perspective view showing the appearance of the image reading device 11, in which a document transport device 20 is opened.

As shown in FIG. 2 and FIG. 3, the image reading device 11 includes the document transport device 20 and a reading unit 30. The document transport device 20 includes a document tray 21, a paper feed roller 22, a resist roller 23, a plurality of transport rollers 26, a discharge roller 27, and a document discharge tray 28. The reading unit 30 includes a first platen glass 31, a second platen glass 32, a carriage 34, an optical system 35, a condenser lens 36, and a CCD sensor 37.

Two hinges 38 are provided, with a spacing between each other, along an edge of an upper face 30a of the reading unit 30, so as to pivotably support the document transport device 20, thereby allowing the user to open and close the document transport device 20.

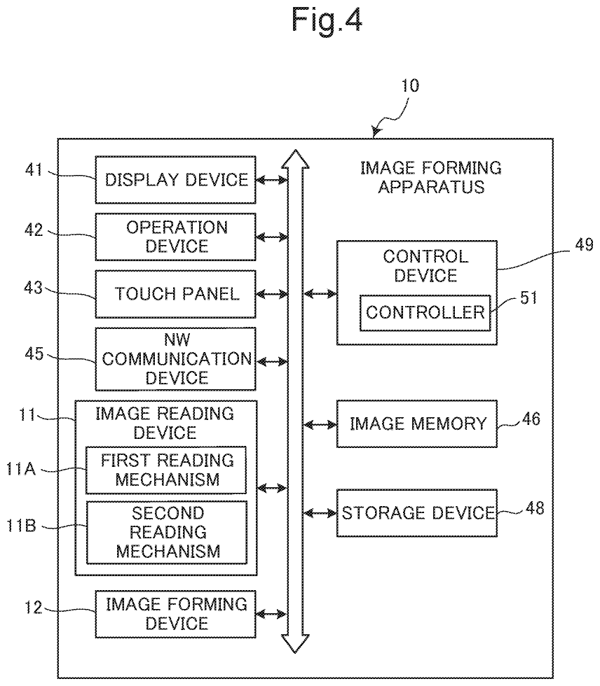

The image reading device 11 also includes a first reading mechanism 11A (see FIG. 4) that reads the image of a source document M placed on the second platen glass 32, and a second reading mechanism 11B (see FIG. 4) that reads the image of the source document M, while the source document M is being transported by the document transport device 20. In addition, for example, a first sensor (not shown) that detects the source document M placed on the second platen glass 32, and a second sensor (not shown) that detects the source document M placed on the document tray 21 of the document transport device 20, are provided. When the first sensor detects the source document M, a controller 51 to be subsequently described (see FIG. 4) selects a first mode, which is a document reading mode including causing the first reading mechanism 11A to read the source document. When the second sensor detects the source document M, the controller 51 selects a second mode, which is a document reading mode including causing the second reading mechanism 11B to read the source document.

In the first mode, the user is supposed to open the document transport device 20 so as to expose the second platen glass 32 of the reading unit 30, place the source document M on the second platen glass 32, and close the document transport device 20 so that the source document M placed on the second platen glass 32 is fixed by the document transport device 20. The reading unit 30 emits the light from a light source 34A of the carriage 34 to the source document M through the second platen glass 32, while moving the carriage 34 and the optical system 35 in a sub scanning direction X, maintaining a predetermined relation in speed therebetween, and reflects the light reflected by the source document M, with a mirror 34B of the carriage 34, under the control of the controller 51. The light reflected by the mirror 34B is further reflected by mirrors 35A and 35B of the optical system 35, and enters the CCD sensor 37 of the condenser lens 36. The CCD sensor 37 repeatedly reads the image of the source document M, in a main scanning direction Y (orthogonal to the sub scanning direction X).

In the second mode, also under the control of the controller 51, the source documents M placed on the document tray 21 are drawn out one by one by the paper feed roller 22 of the document transport device 20, with the document transport device 20 kept closed, transported by the resist roller 23 and the transport rollers 26 in the sub scanning direction, over the first platen glass 31, and discharged to the document discharge tray 28 by the discharge roller 27. In the reading unit 30, the carriage 34 and the optical system 35 are respectively set to the predetermined positions, and the light from the light source 34A of the carriage 34 is emitted to the source document M through the first platen glass 31. The light reflected by the source document M is sequentially reflected by the mirrors 34B, 35A, and 35B, and enters the CCD sensor 37 through the condenser lens 36, so that the CCD sensor 37 repeatedly reads the image of the source document M, in the main scanning direction Y

Hereunder, a configuration for controlling the image forming apparatus 10 will be described. FIG. 4 is a functional block diagram showing an essential internal configuration of the image forming apparatus 10. As shown in FIG. 4, the image forming apparatus 10 according to this embodiment includes the image reading device 11, the image forming device 12, a display device 41, an operation device 42, a touch panel 43, a network (NW) communication device 45, an image memory 46, a storage device 48, and a control device 49. The mentioned components are configured to transmit and receive data or signals to and from each other, via a bus.

The display device 41 is, for example, constituted of a liquid crystal display (LCD) or an organic light-emitting diode (OLED) display.

The operation device 42 includes physical keys such as a tenkey, an enter key, and a start key.

A touch panel 43 is overlaid on the screen of the display device 41. The touch panel 43 is based on a resistive film or electrostatic capacitance, and configured to detect a contact (touch) of the user's finger, along with the touched position, and outputs a detection signal indicating the coordinate of the touched position, to the controller 51 of the control device 49 to be subsequently described. The touch panel 43 serves, in collaboration with the operation device 42, as an operation unit for the user to input instructions through the screen of the display device 41.

The NW communication device 45 includes a communication module such as a LAN board, and performs data communication through a network.

In the image memory 46, the image data representing the image of a source document read by the image reading device 11.

The storage device 48 is a large-capacity storage device such as a solid-state drive (SSD) or a hard disk drive (HDD), and contains various application programs and various types of data.

The control device 49 includes a processor, a random-access memory (RAM), a read-only memory (ROM), and so forth. The processor is, for example, a central processing unit (CPU), an application specific integrated circuit (ASIC), or. a micro processing unit (MPU) The control device 49 acts as the controller 51, when the processor executes a control program stored in the ROM or the storage device 48.

The control device 49 executes overall control of the image forming apparatus 10. The control device 49 is connected to the image reading device 11, the image forming device 12, the display device 41, the operation device 42, the touch panel 43, the network communication device 45, the image memory 46, and the storage device 48, to control the operation of the mentioned components, and transmit and receive data and signals to and from each of those components.

The controller 51 serves as a processing device that executes various operations necessary for the image forming to be performed by the image forming apparatus 10. The controller 51 also receives operational instructions inputted by the user, in the form of a detection signal outputted from the touch panel 43, or through a press of a physical key of the operation device 42. Further, the controller 51 is configured to control the display operation of the display device 41, and the communicating operation of the network communication device 45, and process the image data stored in the image memory 46.

With the image forming apparatus 10 configured as above, the user may, for example, set a source document on the image reading device 11, and press the start key of the operation device 42, so that the controller 51 causes the image reading device 11 to read the image of the source document, and temporarily stores the image data representing the source document image in the image memory 46. Then the controller 51 inputs the image data to the image forming device 12, to thereby cause the image forming device 12 to form the image represented by the image data, on the recording sheet.

In this embodiment, the controller 51 also executes a search function, according to an instruction of the user inputted through the touch panel 43. Upon receipt of the instruction to execute the search function, the controller 51 causes the image reading device 11 to read the image of the source document, and stores the image data representing the read image in the image memory 46. Then the controller 51 designates the image of the source document, or a character string in a text contained in the image, whichever is selected according to a selection instruction inputted by the user through the touch panel 43, as a search condition.

Upon designating the image as the search condition according to the selection instruction, the controller 51 further designates one of color and Monochrome (hereinafter abbreviated as B/W) as the search condition, according to the instruction inputted by the user through the touch panel 43. Then the controller 51 transmits the designated image and one of the color and B/W, as the search condition, to an existing search engine on the network from a browser, through the network communication device 45. The controller 51 further receives, from the search engine through the network communication device 45, the search result obtained by the search engine from a database thereof, through the search performed on the basis of the search condition, and causes the display device 41 to display the search result, on the browser currently displayed thereon. The database contains the data available in web pages on the internet, and collected from each of the web pages.

When the user designates a character string in a text as the search condition, the controller 51 recognizes and extracts the texts contained in the image of the source document stored in the image memory 46, using a known optical character recognition (OCR) function, and displays the text on the screen of the display device 41. When the user inputs an instruction designating a selected character string in the text being displayed, through the touch panel 43, the controller 51 transmits the designated character string, as the search condition, to the existing search engine on the network, from the browser through the network communication device 45. Then the controller 51 receives, from the search engine through the network communication device 45, the search result obtained by the search engine from the database thereof, through the search performed using the character string as the search condition, and causes the display device 41 to display the search result, on the browser currently displayed thereon.

Accordingly, the user can search and acquire another image and the text related to the image of the source document read by the image reading device 11, through the network.

Here, it will be assumed that a known system provided by a search engine provider is utilized as the search engine on the network.

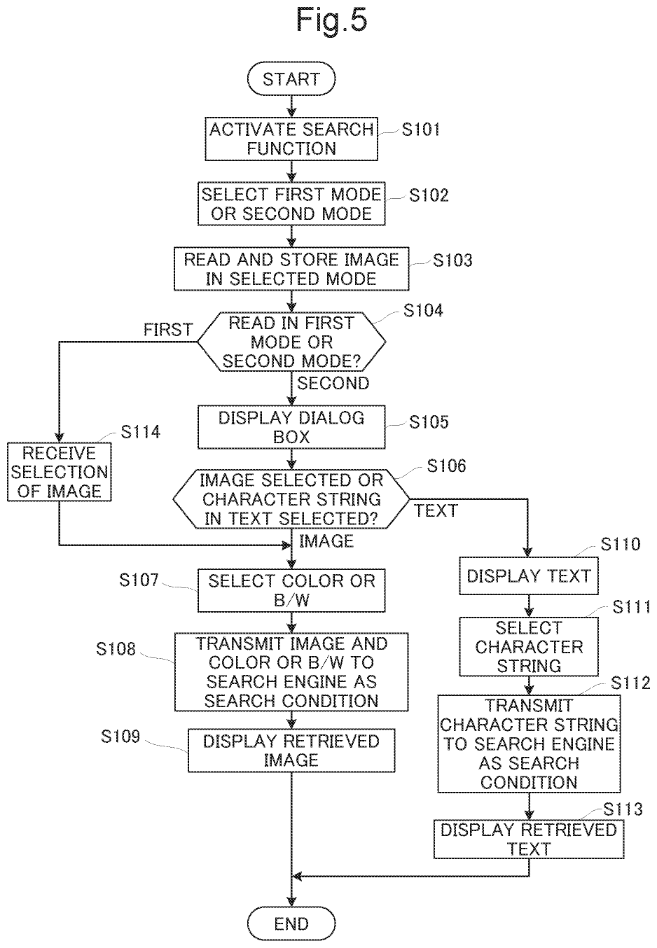

Referring now to the flowchart of FIG. 5, detailed description will be given about a control process for searching and acquiring, through a network, another image and a text related to the source document image read by the image reading device 11.

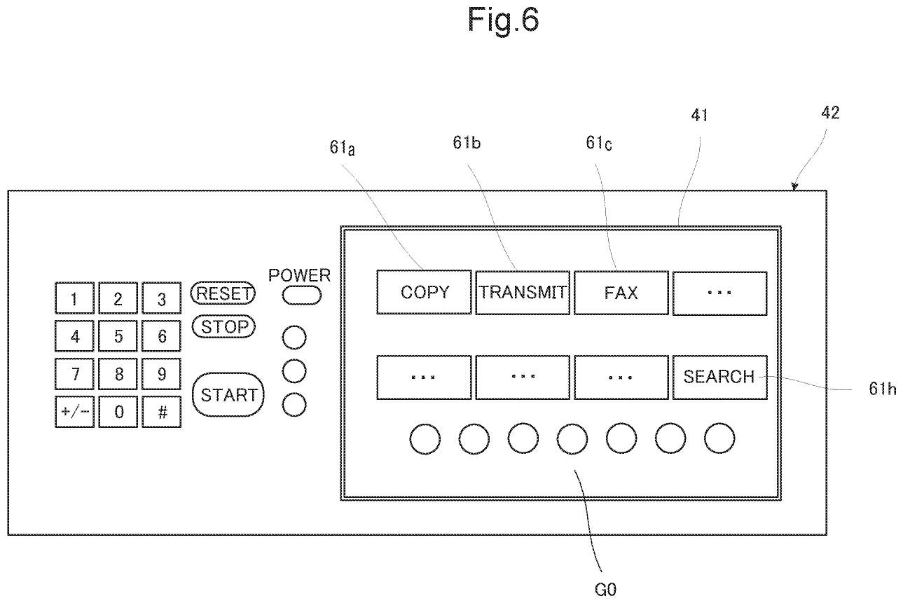

It will be assumed that at first the controller 51 has caused the display device 41 to display an initial screen G0 as shown in FIG. 6. The initial screen G0 includes a plurality of function keys K61a to 61h, each associated with a corresponding function. When the user touches the function key 61h for selecting the search function while the initial screen is displayed, the controller 51 receives, through the touch panel 43, the instruction to execute the search function corresponding to the function key 61h, and activates the search function, according to the instruction received (S101).

When the search function is activated, the user sets a source document on the image reading device 11, and presses the start key on the operation device 42. Upon receipt of the instruction to read the source document corresponding to the press of the start key, the controller 51 selects the first mode including reading the image of the source document placed on the second platen glass 32, when a detection output is received from the first sensor that detects the source document placed on the second platen glass 32, and selects the second mode including reading the image of the source document while the source document is transported by the document transport device 20, when a detection output is received from the second sensor that detects the source document placed on the document tray 21 of the document transport device 20 (S102). The controller 51 then causes the image reading device 11 to read the image of the source document in one of the first mode and the second mode whichever has been selected, and stores the image data representing the source document image, in the image memory 46 (S103).

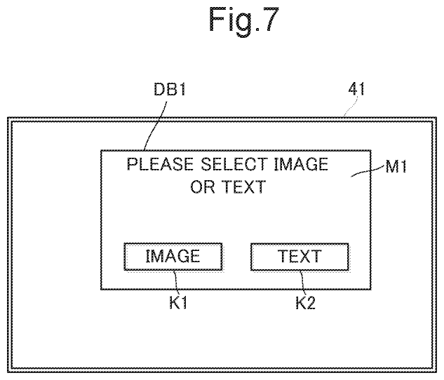

When the source document is read in the second mode (“SECOND” at S104), the controller 51 causes the display device 41 to display a dialog box DB1 for selecting, as the search condition, one of the source document image and a character string in the text contained in the image, as shown in FIG. 7 (S105). The dialog box DB1 includes a message M1 urging the user to select one of the image and the text, an image selection key K1 for selecting the image, and a text selection key K2 for selecting the text.

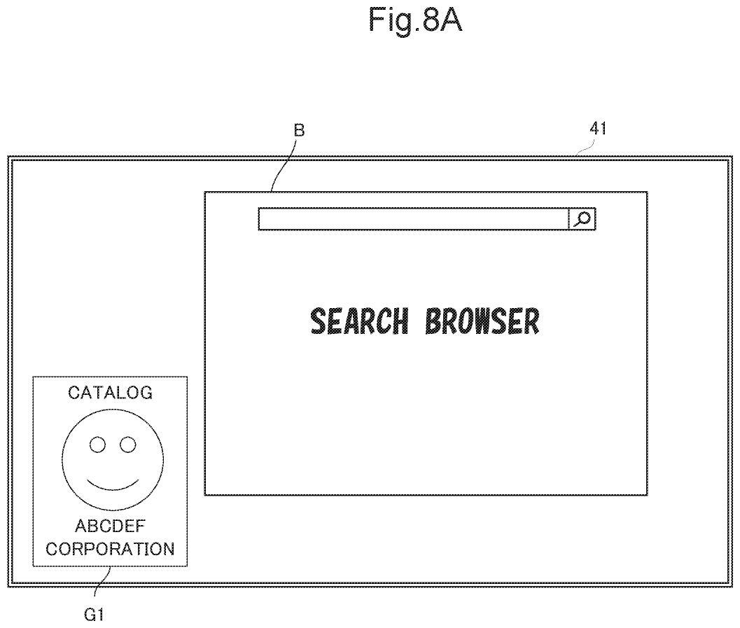

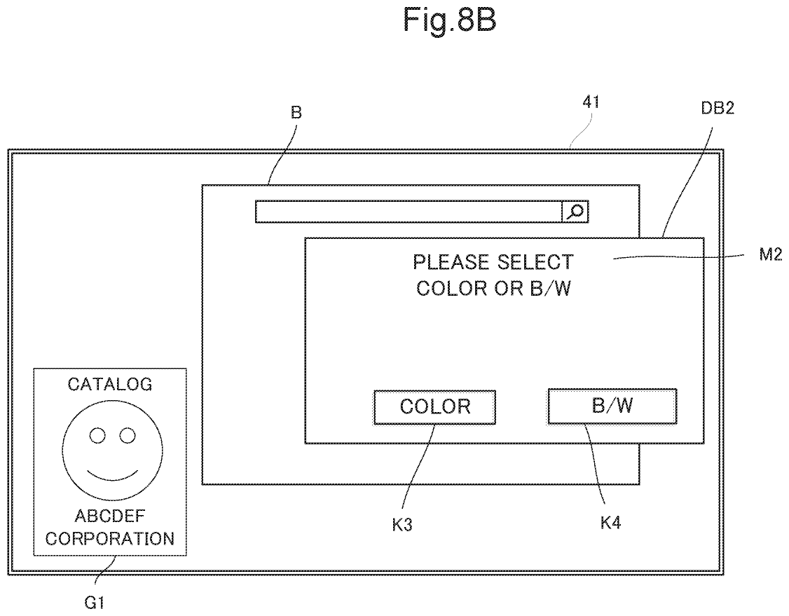

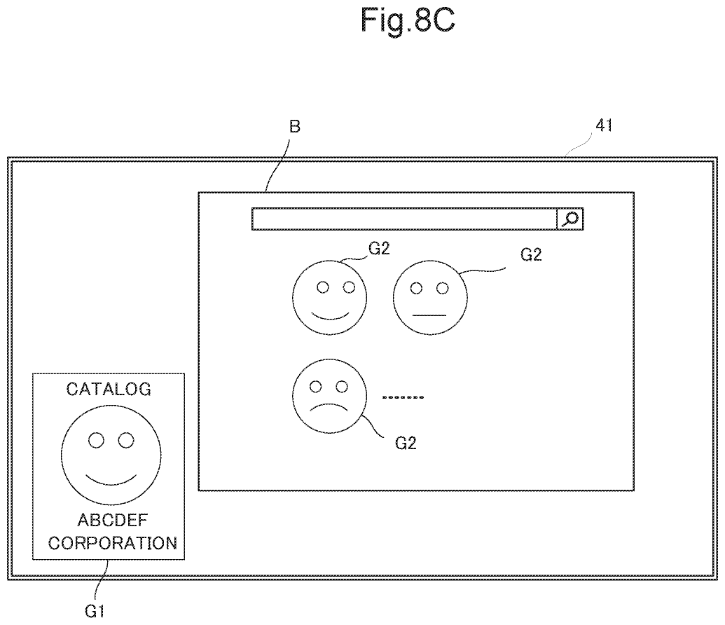

When the user touches the image selection key K1 in the dialog box DB1, the controller 51 receives, through the touch panel 43, the instruction to select the image, corresponding to the image selection key K1 (“IMAGE” at S106). Then the controller 51 causes the display device 41 to display an image G1 in the image memory 46, a predetermined a browser B, and a dialog box DB2 for urging the user to select one of color and B/W as the search condition, as the example shown in FIG. 8B (S107). The dialog box DB2 includes a message M2 urging the user to select one of color and B/W, a color selection key K3 for selecting color, and a B/W selection key K4 for selecting B/W. The user touches the color selection key K3 or the B/W selection key K4 in the dialog box DB2.

When the user touches the color selection key K3, the controller 51 receives the instruction to select the color corresponding to the color selection key K3, through the touch panel 43. The controller 51 then causes the network communication device 45 to transmit, as the search condition, the image G1 displayed on the display device 41, and the instruction to select the color image, to the search engine on the network via the browser B (S108).

When the user touches the B/W key K4, the controller 51 receives the instruction to select B/W corresponding to the B/W key K4, through the touch panel 43. The controller 51 then causes the network communication device 45 to transmit, as the search condition, the image G1 displayed on the display device 41, and the instruction to select the B/W image, to the search engine on the network via the browser B (S108).

The search engine searches the database using the image G1 (or an image region contained in the image G1) and one of the color and B/W as the search condition, and transmits the search result to the image forming apparatus 10. Upon receipt of the search result, in other words the image retrieved through the search performed by the search engine, through the network communication device 45, the controller 51 of the image forming apparatus 10 causes the display device 41 to display the image retrieved as the search result, on the browser B (S109). For example, when the image G1 (or the image region contained in the image G1) and the color are transmitted as the search condition to the search engine on the network, the color image retrieved by the search engine is received and displayed on the browser B. When the image G1 (or the image region contained in the image G1) and B/W are transmitted as the search condition to the search engine on the network, the B/W image retrieved by the search engine is received and displayed on the browser B. As result, the browser B including the color or B/W images G2 retrieved by the search engine is displayed on the display device 41, together with the image G1 in the image memory 46, as shown in FIG. 8C. When a plurality of images G2 has been retrieved, the images G2 that have been retrieved are displayed on the browser B, in a predetermined pattern.

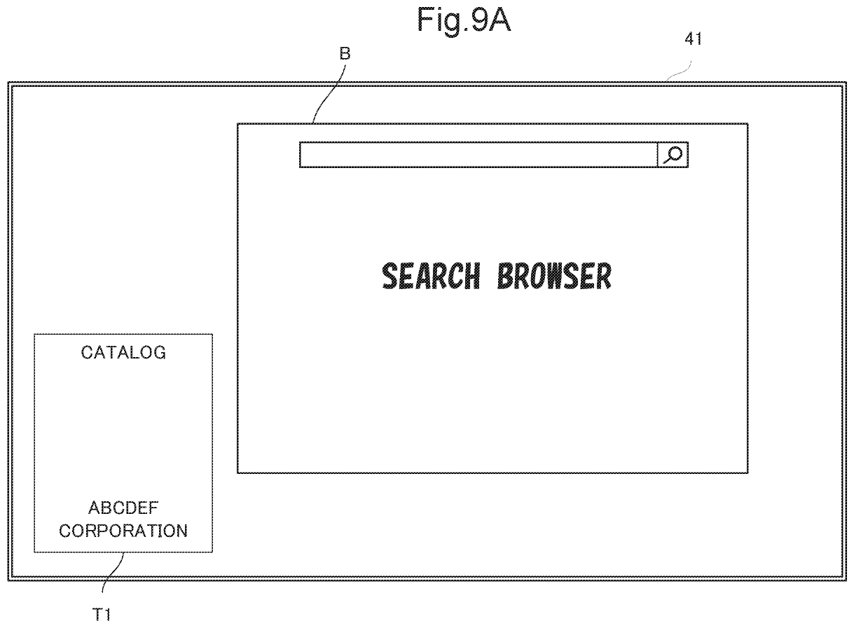

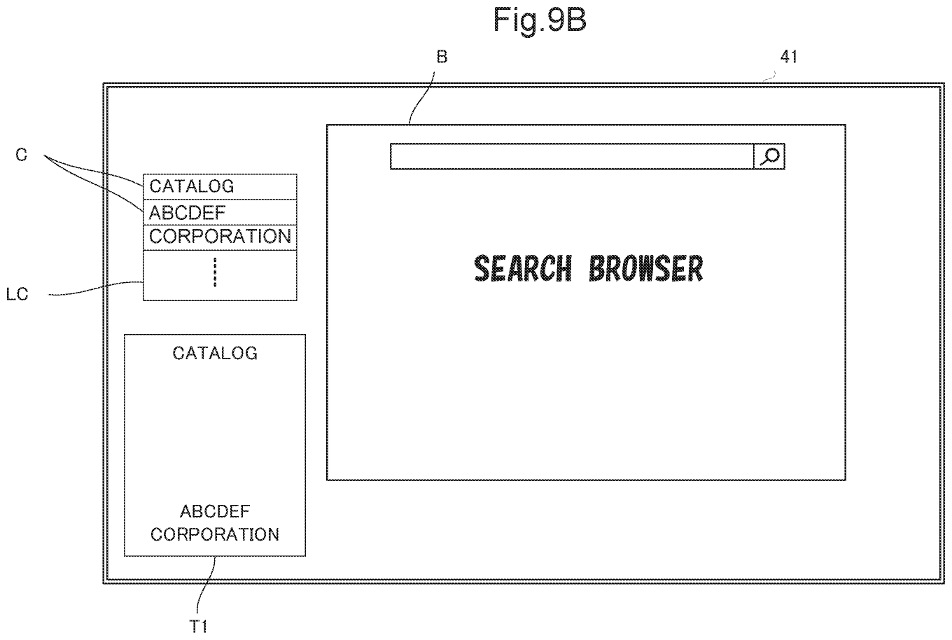

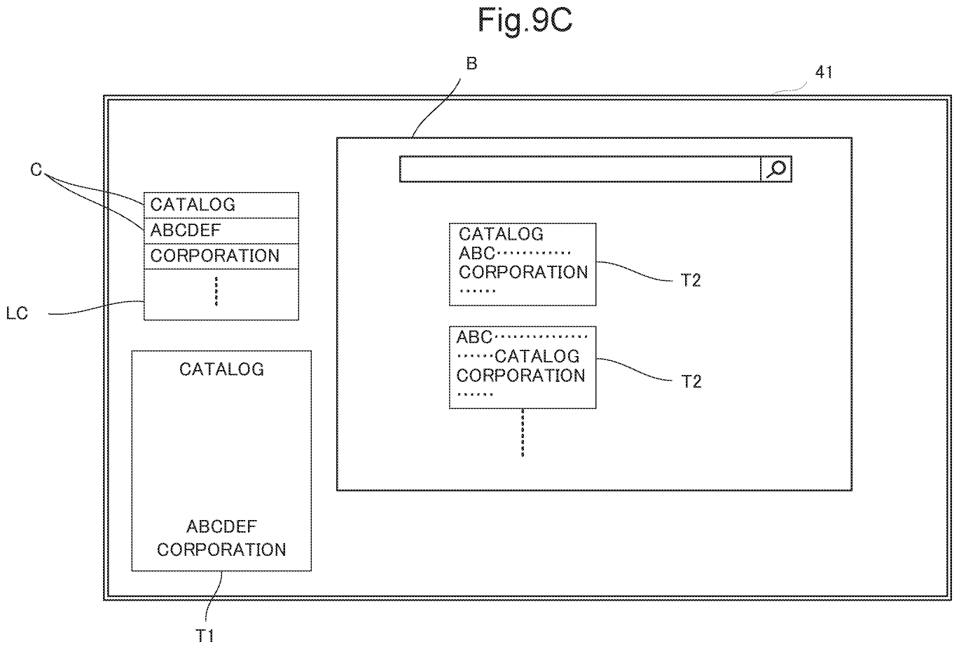

When the user touches at S106 the text selection key K2 in the dialog box DB1 shown in FIG. 7, the controller 51 receives, through the touch panel 43, the instruction to select the text corresponding to the text selection key K2 (“TEXT” at S106). Then the controller 51 recognizes and extracts the text contained in the source document image in the image memory 46 with a known OCR technique, and causes the display device 41 to display the extracted text T1 and the browser B, as the example shown in FIG. 9A (S110).

The user can designate, through the touch panel 43, the text to be retrieved, by touching the region on the screen of the display device 41 where the character string of the text T1 is displayed, and sliding the touched region. The controller 51 causes the display device 41 to display the character string designated as above through the touch panel 43, as a character string C, as the example shown in FIG. 9B (S111). When a plurality of character strings are designated by the sliding operation performed on the touch panel 43, the controller 51 causes the display device 41 to display a list LC indicating the plurality of character strings C that have been designated.

Then the controller 51 transmits all of the designated character strings to the search engine as the search condition, from the browser B through the network communication device 45 (S112).

The search engine searches the database using the character strings as the search condition, and transmits the search result, in other words the data retrieved through the search performed by the search engine (in this example, the text is retrieved as the search result), to the image forming apparatus 10. Upon receipt of the search result obtained by the search engine through the search of the database using the character strings as the search condition, through the network communication device 45, the controller 51 of the image forming apparatus 10 causes the display device 41 to display the text transmitted as the search result, on the browser B (S113). As result, as the example shown in FIG. 9C, the browser B showing a text T2 retrieved by the search engine is displayed on the display device 41, together with the text T1 extracted from the image G1 in the image memory 46. When a plurality of texts T2 is retrieved, the retrieved texts T2 are displayed on the browser B, in a predetermined pattern.

When the source document is read in the first mode (“FIRST” at S104), the controller 51 receives the instruction to designate the image as the search condition (S114), and causes the display device 41 to display the image G1 in the image memory 46 and the browser B, as the example shown in FIG. 8A. The controller 51 then performs the operation according to S107 to S109. This is because the source document is more likely to contain image regions rather than texts, when the user selects the first mode to cause the image reading device 11 to read the source document one by one. For example, it is presumed that the first mode is selected rather than the second mode, when an image printed on a photo paper, an ink jet paper, or a glossy paper is to be read, because the paper media such as the photo paper, glossy paper, and ink jet paper are stiff, which induces the user to select the first mode to prevent paper jam during the transport of the source document. In addition, examples of the source documents that have to be read in the first mode include book-type documents, such as an image book and a design book, the major part of which is occupied with images. Therefore, the controller 51 is configured to receive the instruction to select the image as the search condition when the source document is read in the first mode, on the assumption that the source document read in the first mode is likely to contain large image regions. Such an arrangement leads to improved user-friendliness.

In this embodiment, as described above, the image of a source document read by the image reading device 11, or a text contained in the image, is designated as the search condition, to retrieve another image or a text related to the image or the text through an existing search engine on the network, and another image or text thus retrieved is displayed on the screen of the display device 41. Accordingly, the object of the search can be easily designated, when the search is to be performed to obtain the image or text. Further, the other image or the text that has been retrieved can be stored in the storage device 48 by operating the touch panel 43 or operation device 42, or formed on a recording sheet by the image forming device 12.

Now, since the image forming apparatus includes the image reading device that reads the image of the source document, improved user-friendliness can be attained by acquiring another image or text related to the image of the source document that has been read, through a searching of a database on the network.

With the specific image forming apparatus referred to above as background art, the web page corresponding to the URL on the URL table, and the web page linked with the hypertext character string in the character string table are acquired, and printed in a combined form. However, another image or text related to the image of the source document that has been read by the image reading device is not acquired.

According to this embodiment, in contrast, the object of the search can be easily designated, when an image or a text is to be retrieved.

Further, with the arrangement according to this embodiment, even when a part of the image that has been read, or a part of the character string that has been read is missing, the entire image and the character string without a missing part can be retrieved as search result, through the search using the image or character string a part of which is missing, as it is.

In the foregoing embodiment, the controller 51 designates a single image in the source document ready by the image reading device 11, or at least one character string of a single text contained in the image, as the search condition. However, when a plurality of images or a plurality of texts are contained in one source document read by the image reading device 11, or when an image or text is contained in each of a plurality of source documents read by the image reading device 11, the browser B may be sequentially displayed on the display device 41 with respect to each of the images or the texts, to transmit the image or the character string of the text as the search condition to the search engine on the network, from each of such browsers B, receive the search result corresponding to each of the cases from the search engine through the network communication device 45, and display the search result on each of the browsers B.

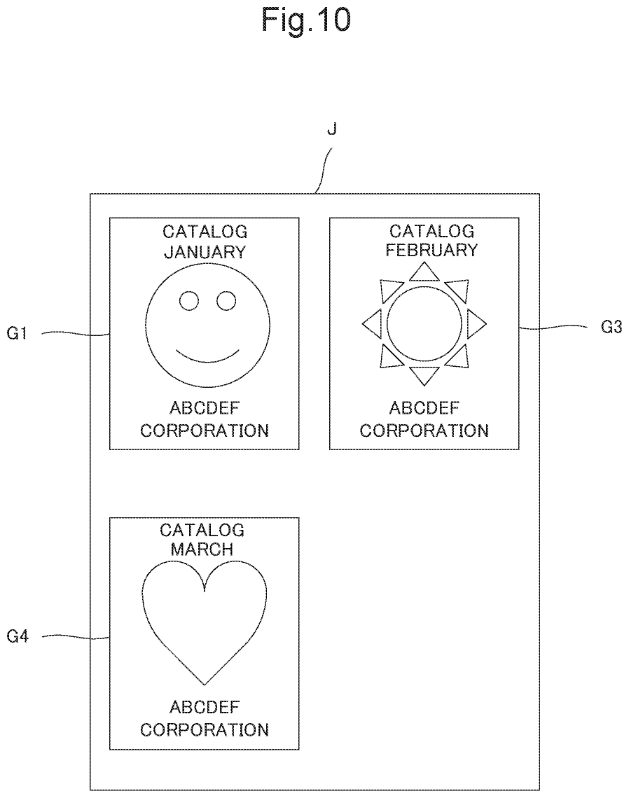

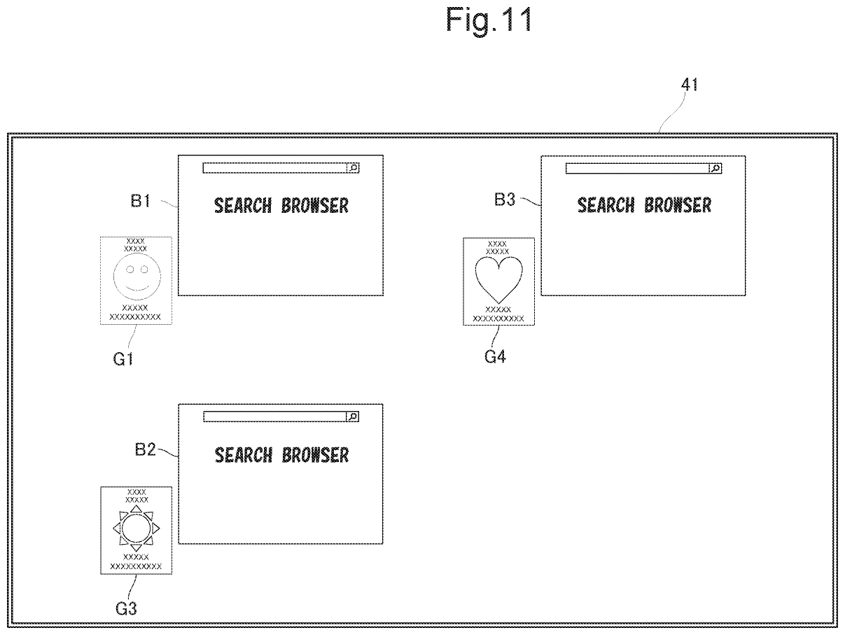

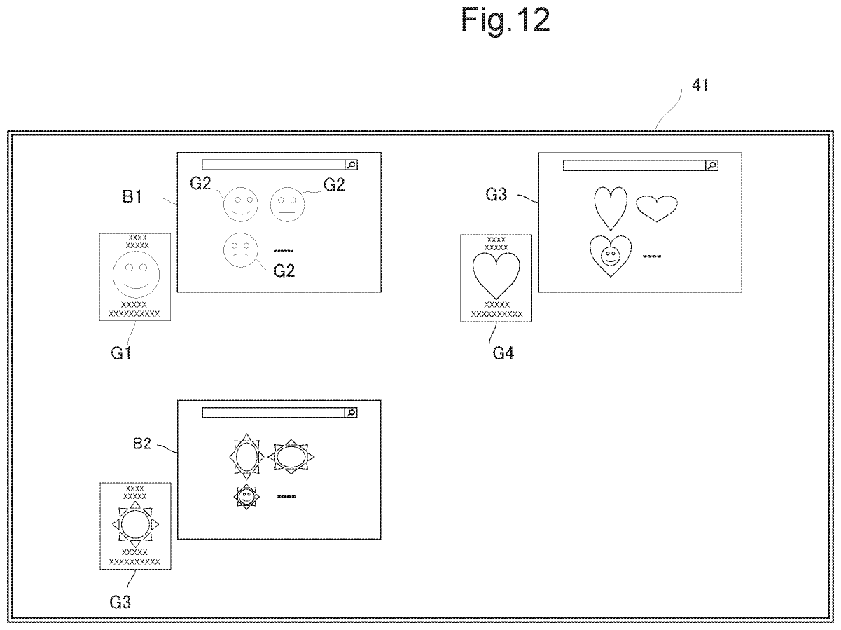

For example, in the case where three images G1, G3, and G4 are contained in one source document J as shown in FIG. 10, when the entire image of the source document J is read by the image reading device 11 and stored in the image memory 46, the controller 51 extracts the images G1, G3, and G4 from the entire image of the source document J in the image memory 46. For example, the controller 51 detects blank regions between the images G1, G3, and G4 in the entire image of the source document J, and extracts the regions defined by the blank regions, as the images G1, G3, and G4. The controller 51 then causes the display device 41 to display the browsers B1, B2, and B3, respectively corresponding to the images G1, G3, and G4, as the example shown in FIG. 11. The controller 51 transmits the image to the search engine on the network as the search condition, with respect to each of the images G1, G3, and G4, and displays the search results on the respective browsers B1, B2, and B3, as the example shown in FIG. 12.

In this case, the controller 51 decides whether the source document read by the image reading device 11 was formed by aggregate printing, on the basis of the blank region in the entire image of the source document J. For example, when the blank regions between the images G1, G3, and G4 are detected in the entire image of the source document J, the controller 51 decides that the source document read by the image reading device 11 was formed by aggregate printing. On the other hand, when a blank region is not detected between the images G1, G3, and G4 in the entire image of the source document J, the controller 51 decides that the source document read by the image reading device 11 was not formed by aggregate printing. Upon deciding that the source document was formed by aggregate printing, the controller 51 causes the display device 41 to display the browsers B respectively showing the images G1, G3, and G4 contained in the source document, to acquire the search results from the search engine with respect to the respective images, and then causes the display device 41 to display the search results in the corresponding browsers B.

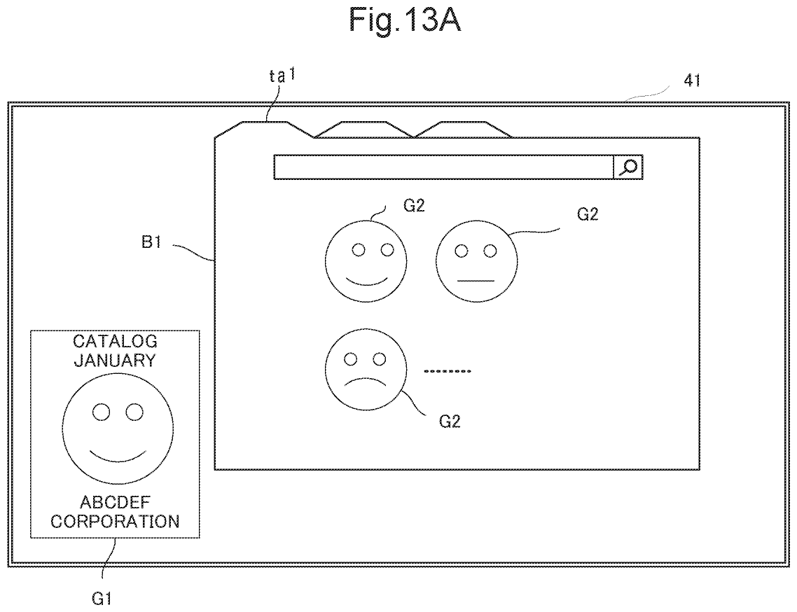

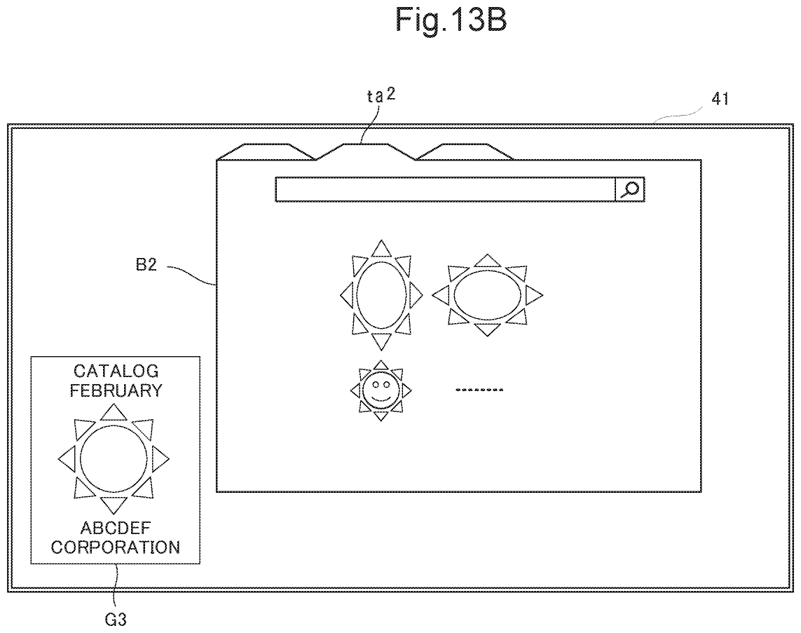

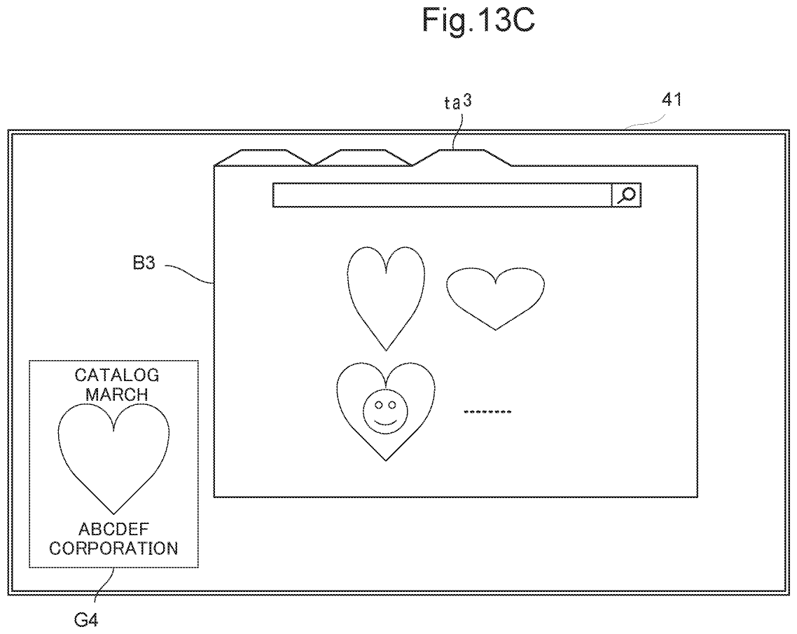

Here, the controller 51 may cause the display device 41 to display the browsers B1, B2, and B3 respectively showing the images G1, G3, and G4, in a tab format, as the examples shown in FIG. 13A to FIG. 13C. In this case, when the user touches one of tabs ta1 to ta3 respectively representing the browsers B1 to B3, the controller 51 receives, through the touch panel 43, the instruction to display the browser corresponding to the touched tab, and causes the display device 41 to display the designated browser.

As described above, when the three images G1, G3, and G4 are contained in one source document J, the controller 51 decides that the source document J was formed by aggregate printing, on the basis of the blank region between the images G1, G3, and G4 in the entire image of the source document, and extracts the images G1, G3, and G4 as separate pages. Instead, the controller 51 may, for example, decide that the source document read by the image reading device 11 was formed by aggregate printing, (1) when an image indicating the boundary between the images is detected, or (2) when an image indicating the page number accompanying each of the images is detected. In the negative case, the controller 51 decides that the source document was not formed by aggregate printing. Then the controller 51 may (1) detect the image indicating the boundary between the images, and extract the regions defined by the detected boundary as the images G1, G3, and G4, or (2) detect the image indicating the page number accompanying each of the images, and extract each of the images containing therein the page number, and covering a predetermined area around the page number, as the images G1, G3, and G4. In this case, the controller 51 individually transmits the extracted images G1, G3, and G4 to the search engine as the search condition, and receives the individual search result from the search engine with respect to each of the images G1, G3, and G4. Alternatively, the controller 51 may set up a single search condition from the plurality of images extracted as (1) or (2) above, namely all of the images G1, G3, and G4 (search condition combining the images G1, G3, and G4 with AND), transmit such a search condition to the search engine, and receive the search result in response to the search condition, from the search engine.

Although the search engine and the database on the network are utilized in the foregoing embodiment, the data possessed by each of the web pages accessible on the internet may be collected by the image forming apparatus 10, and stored in advance in the storage device 48, and the controller 51 may act as a search engine to search the data stored in the storage device 48, using the search condition designated as above.

Further, the configurations and processings according to the foregoing embodiment, described with reference to FIG. 1 to FIG. 13C, are merely exemplary and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An image reading apparatus comprising:
a display device;
an image reading device that reads an image of a source document;
an operation device to be used by a user to input an instruction to select one of the image of the source document read by the image reading device, and a character string in a text included in the image, as a search condition; and
a control device including a processor, and configured to act, when the processor executes a control program, as a controller that:
acquires, when the instruction designating the image as the search condition is inputted through the operation device, a search result obtained through a search performed by a search engine using the image as the search condition, and causes the display device to display the search result; and
acquires, when the instruction designating the character string in the text as the search condition is inputted through the operation device, a search result obtained through a search performed by the search engine using the character string in the text as the search condition, and causes the display device to display the search result.

2. The image reading apparatus according to claim 1, further comprising a communication device that performs data communication through a network,
wherein the search engine includes a search engine on the network,
the controller transmits the search condition to the search engine on the network, through the data communication of the communication device, acquires the search result from the search engine, and causes the display device to display the search result.

3. The image reading apparatus according to claim 1,
wherein the controller adds one of monochrome and color to the search condition of the image, when an instruction to select one of monochrome and color is inputted through the operation device.

4. The image reading apparatus according to claim 3,
wherein the controller (i) adds monochrome to the search condition of the image, when the instruction to select monochrome is inputted through the operation device, acquires a monochrome image obtained by the search engine as a result of a search performed using the image and monochrome as the search condition, and causes the display device to display the acquired image, and (ii) adds color to the search condition of the image, when the instruction to select color is inputted through the operation device, acquires a color image obtained by the search engine as a result of a search performed using the image and color as the search condition, and causes the display device to display the acquired image.

5. The image reading apparatus according to claim 1,
wherein the controller designates, when the instruction to select the character string in the text is inputted through the operation device, the selected character string as the search condition of the text.

6. The image reading apparatus according to claim 1,
wherein the image reading device includes a first reading mechanism that reads an image of a source document placed on a platen glass, and a second reading mechanism that reads an image of a source document while the source document is being transported,
the controller acquires the search result obtained through the search performed by the search engine using the image as the search condition, when the image of the source document is read by the first reading mechanism, and causes the display device to display the search result, and
the controller acquires, according to the instruction to select one of the image of the source document and the character string in the text contained in the image as the search condition, inputted through the operation device, a search result obtained through a search performed by the search engine according to the instruction, and causes the display device the search result.

7. The image reading apparatus according to claim 1,
wherein, when a plurality of source documents are read by the image reading device, the controller causes the display device to display browsers for causing the search engine to perform a search, with respect to the respective source documents, acquires search results from the search engine with respect to the respective source documents, and causes the display device to display the search results on the browsers respectively corresponding to the source documents.

8. The image reading apparatus according to claim 7,
wherein the controller decides whether the source document read by the image reading device was formed by aggregate printing, and causes the display device, upon deciding that the source document was formed by aggregate printing, to display the browsers respectively corresponding to the images contained in the image of the source document, acquires search results from the search engine with respect to the respective images, and causes the display device to display the search results on the browsers respectively corresponding to the images.

9. The image reading apparatus according to claim 8,
wherein the controller decides whether the source document read by the image reading device was formed by aggregate printing, on a basis of an image indicating a boundary, or an image indicating a page number, contained in the image of the source document read by the image reading device.

10. An image forming apparatus comprising:
the image reading apparatus according to claim 1; and
an image forming device that forms an image on a recording medium.
